(19) United States
(12) Patent Application Publication
(10) Pub. No.: US 2025/0332967 A1
(43) Pub. Date: Oct. 30, 2025

(54) CHILD SAFETY SEAT AND SAFETY BELT ADJUSTMENT SYSTEM THEREOF

(71) Applicant: WONDERLAND SWITZERLAND AG, Steinhausen (CH)

(72) Inventors: Zhengwen GUO, Dongguan, Guangdong (CN); Daliang ZHANG, Dongguan, Guangdong (CN)

(73) Assignee: WONDERLAND SWITZERLAND AG, Steinhausen (CH)

(21) Appl. No.: 18/875,593

(22) PCT Filed: Jun. 19, 2023
(86) PCT No.: PCT/EP2023/066412

§ 371 Date: Dec. 16, 2024

(30) Foreign Application Priority Data
Jun. 17, 2022 (CN) 202210691997.4

(51) Int. Cl. B60N 2/28; B60R 22/34

(52) U.S. Cl. CPC B60N 2/2806; B60N 2/2816; B60R 22/3416; B60N 2/28; B60N 2/2803; B60R 22/34; B60R 22/347; B60R 22/35; B60R 22/357; B60R 22/44; B60R 22/46; B60R 22/4604; B60R 22/4619; B60R 22/4623; B60R 22/4671; B60R 22/48; B60R 2022/4808; B60R 2022/4866; B60R 2022/4883

(57) ABSTRACT

The present application discloses a child safety seat and a safety belt adjustment system thereof. The safety belt adjustment system includes: an automatic retracting device including a retracting shaft and a retractor, the retracting shaft being configured to be connected to a safety belt, the retractor driving the retracting shaft to perform a retracting rotation, so as to tension the safety belt in a buckled state; and a first locking device including a drive button and a locking member; the drive button being configured to drive the retracting shaft to perform a release rotation. The locking member has a locked position. In the locked position, the locking member locks the retracting rotation of the retracting shaft.

### CROSS-REFERENCE TO RELATED APPLICATIONS

This application is a National Stage application of PCT/EP2023/066412, filed on Jun. 19, 2023, which claims priority to Chinese Patent Application No. 2022106919974, filed on Jun. 17, 2022, the content of which is incorporated herein by reference in its entirety.

### TECHNICAL FIELD

The present application relates to a child safety seat and a safety belt adjustment system thereof.

### BACKGROUND

A child safety seat (including a baby carrier) is generally secured to a vehicle seat and may use its own safety belt system to restrain a child in a seat of the child safety seat, so as to protect the child from being impacted in the case of vehicle collision, emergency braking, and other accidents.

A seat belt of a conventional child safety seat generally includes two shoulder belts and an adjustment belt. Two sub-buckles are arranged on portions of the two shoulder belts in front of a backrest of the child safety seat respectively. The two sub-buckles may be joined to each other to form a male buckle. Portions of the two shoulder belts behind the backrest are both connected to a rear end of the adjustment belt, and a front end of the adjustment belt protrudes from a front end of a seat portion of the child safety seat. The seat portion of the child safety seat is further provided with a crotch belt, and a female buckle is arranged on the crotch belt. When the male buckle and the female buckle are fastened to each other, it means that the safety belt is in a buckled state, and when the male buckle and the female buckle are disengaged from each other, it means that the safety belt is in an unbuckled state.

When the child is seated in a child safety seat, a user (such as a parent nursing the child) firstly fastens the male buckle of the shoulder belt and the female buckle of the crotch belt to each other, and then manually pulls the adjustment belt to tension the entire safety belt. In this case, an adjustment belt locking device automatically limits movement of the adjustment belt, so that the safety belt is kept tensioned, thereby securely restraining the child in the child safety seat.

In the related art, the safety belt is provided with an automatic retracting device. The automatic retracting device is provided with a coil spring and a retracting shaft. The front end of the adjustment belt is connected to the retracting shaft. The coil spring exerts a retracting force for retracting the adjustment belt on the retracting shaft. In this way, there is no need to manually pull the adjustment belt, and the safety belt in the buckled state is automatically tensioned. However, it is difficult to control the retracting force exerted by the coil spring on the retracting shaft, which may easily cause the safety belt to be extremely tight or extremely loose, and it is difficult to balance comfort and safety of the child during being seated.

### SUMMARY

The present application is to provide a child safety seat and a safety belt adjustment system thereof, so as to achieve comfort and safety of the child during being seated.

In an aspect, the present application provides a safety belt adjustment system for a child safety seat. The safety belt adjustment system includes: an automatic retracting device including a retracting shaft and a retractor, the retracting shaft being configured to be connected to a safety belt, the retractor driving the retracting shaft to perform a retracting rotation for retracting the safety belt, so as to tension the safety belt in a buckled state; and a first locking device including a drive button and a locking member; the drive button being configured to drive the retracting shaft to perform a release rotation for releasing the safety belt. The locking member has a locked position. In the locked position, the locking member locks the retracting rotation of the retracting shaft.

In an embodiment, the locking member further locks the release rotation of the retracting shaft in the locked position, and the locking member has an unlocked position for unlocking the retracting shaft. When the safety belt is in an unbuckled state, the locking member is in the unlocked position. After the safety belt is in the buckled state and is tensioned by the automatic retracting device, a pressing force is applied to the drive button to drive the retracting shaft to perform the release rotation, so that the locking member is switched from the unlocked position to the locked position while the retracting shaft releases the safety belt of a predetermined length.

In an embodiment, the automatic retracting device further includes a support. The retracting shaft and the retractor are mounted on the support. The support is adapted to be mounted on a seat housing of the child safety seat. The drive button is adapted to be mounted on the seat housing.

In an embodiment, the drive button includes a pressing end and an abutting end opposite to the pressing end. When the drive button is subjected to the pressing force, the abutting end presses against a portion of the safety belt not wound around the retracting shaft, and the safety belt is deformed subjected to a force applied by the abutting end and drives the retracting shaft to perform the release rotation.

In an embodiment, after the locking member is switched from the unlocked position to the locked position, the pressing force is removed, the drive button is reset, and the locking member is held in the locked position. When the safety belt is switched from the buckled state to the unbuckled state, the locking member is switched from the locked position to the unlocked position.

In an embodiment, the safety belt adjustment system further includes a second locking device. The second locking device includes a ratchet, a pawl, and a second elastic element. The ratchet is connected to the retracting shaft. The pawl is pivotally connected to the support through a second pivot and connected to a cable. When the safety belt is switched from the unbuckled state to the buckled state, the pawl is pulled by the cable and is rotated to be disengaged from the ratchet. When the safety belt is switched from the buckled state to the unbuckled state, the pawl is driven by the second elastic element and is rotated to be engaged with the ratchet, thereby locking the retracting rotation of the retracting shaft. When the pawl is disengaged from the ratchet and the locking member is switched to the locked position, the pawl is capable of acting on the locking member to hold the locking member in the locked position. When the pawl is engaged with the ratchet, the locking member is allowed to return to the unlocked position.

In an embodiment, the second pivot supports the safety belt outside the retracting shaft, and the abutting end of the drive button is positioned between the retracting shaft and the second pivot.

In an embodiment, the locking member includes a first supporting portion and a lock pin portion. The first supporting portion is pivotally connected to the support through a first pivot. The first pivot is parallel to the retracting shaft. The lock pin portion is connected to the first supporting portion. The locking member rotates around the first pivot to switch between the locked position and the unlocked position. The support is provided with a first groove; and a locking gear is mounted on the retracting shaft. A second groove is formed between every two adjacent teeth of the locking gear. When the locking member is in the locked position, the lock pin portion is snapped into the first groove and the second groove aligned with the first groove. When the locking member is in the unlocked position, the lock pin portion is separated from the first groove and the second groove.

In an embodiment, the first locking device further includes a first elastic member, a third elastic member, a pivot arm, and a pushing member. The first elastic member applies a first torque to the locking member to rotate the locking member toward the locked position. A middle portion of the pivot arm is pivotally connected to the support through a third pivot. The third pivot is parallel to the first pivot, and a first half arm of the pivot arm abuts against the first supporting portion. The third elastic member drives the pivot arm to rotate around the third pivot in a first direction, so that the first half arm applies a second torque to the first supporting portion to rotate the locking member toward the unlocked position. The pushing member is connected to the drive button. The pushing member pushes a second half arm of the pivot arm when the drive button is subjected to the pressing force, so that the pivot arm rotates around the third pivot in a second direction, until the second half arm abuts against the pawl. The second direction is opposite to the first direction.

In an embodiment, the pawl includes a claw portion and an abutting portion. The claw portion is connected to the cable and configured to be engaged with the ratchet. An extending direction of the abutting portion is opposite to an extending direction of the claw portion. The abutting portion is configured to abut against the second half arm to limit rotation of the pivot arm in the first direction.

In an embodiment, the abutting portion includes a side contact wall and a limiting step at an end portion of the side contact wall. When the pawl is separated from the ratchet and the pivot arm rotates in the second direction, an end portion of the second half arm abuts against the side contact wall, until the end portion of the second half arm passes over the side contact wall and abuts against the limiting step.

In an embodiment, the claw portion and the abutting portion are separated parts. The claw portion and the abutting portion are sleeved on the second pivot.; The second elastic element is a torsion spring. The torsion spring is sleeved on the second pivot and positioned between the claw portion and the abutting portion. Two spring arms of the torsion spring are respectively connected to the claw portion and the abutting portion.

In an embodiment, the first locking device further includes a mounting rack. The mounting rack is connected to the support. A middle portion of the pushing member is pivotally connected to the mounting rack through a fourth pivot. The fourth pivot is perpendicular to the retracting shaft. A first end of the pushing member is bent and connected to the drive button. When the drive button is subjected to the pressing force, the drive button drives the pushing member to rotate around the fourth pivot, so that a second end of the pushing member pushes the second half arm.

In an embodiment, the pushing member is made of an elastically deformable metal rod. A middle portion of the metal rod forms a ring capable of being wound around the fourth pivot.

In an embodiment, the mounting rack is connected to the support through the second pivot, and a rotation stopping structure configured to limit rotation of the mounting rack around the second pivot is arranged between the mounting rack and the support.

In an embodiment, a shaft sleeve is further sleeved on the second pivot.

In an embodiment, the mounting rack includes a first frame and a second frame arranged opposite to each other, and a third frame connected between the first frame and the second frame. The second pivot extends through the first frame and the second frame. The safety belt passes between the second pivot and the third frame. The third frame is provided with an outwardly protruding hinge base, and the fourth pivot is connected to the hinge base.

In an embodiment, the rotation stopping structure includes limiting recesses arranged on the first frame and the second frame, and connecting lugs arranged on the support. The connecting lugs are snapped into the limiting recesses respectively. The second pivot extends through the limiting recesses and the connecting lugs.

In an embodiment, the seat housing is provided with a display window. The locking member further includes a second supporting portion. The second supporting portion is connected to the first supporting portion. An indicator is arranged on the second supporting portion. The indicator includes a first indication region and a second indication region. When the locking member is in the locked position, the first indication region of the indicator faces the display window, and when the locking member is in the unlocked position, the second indication region of the indicator faces the display window.

In an embodiment, the seat housing is provided with a reminder device. The reminder device is configured to remind a position state of the locking member.

In an embodiment, the reminder device includes a sound reminder and/or a display reminder.

In an embodiment, the support includes a first sidewall and a second sidewall opposite to the first sidewall. A first end of the retracting shaft extends through the first sidewall, and a second end of the retracting shaft extends through the second sidewall. The ratchet is mounted at the first end of the retracting shaft, and the retractor is mounted at the second end of the retracting shaft. The pivot arm is pivotally connected to the first sidewall through the third pivot. The pivot arm is positioned on an outer side of the first sidewall. Two locking gears are provided. One of the two locking gears is close to an inner side of the first sidewall, and the other of the two locking gears is close to an inner side of the second sidewall. A length of the lock pin portion spans the first sidewall and the second sidewall. The first sidewall and the second sidewall are each provided with the first groove.

In an embodiment, the seat housing includes a seat portion. The seat portion includes a cavity for accommodating the support. A cover is mounted on the top of the cavity. The drive button is mounted on the cover. A reset spring is mounted between the cover and the drive button.

In an embodiment, the safety belt adjustment system further includes a pulling mechanism. The pulling mechanism including the cable. When the safety belt is switched from the unbuckled state to the buckled state, the pulling mechanism driving, through the cable, the pawl to be separated from the ratchet.

In an embodiment, the safety belt is provided with a first buckle; the safety belt adjustment system further includes a crotch belt. The crotch belt is provided with a second buckle. The pulling mechanism includes a rod member, the cable, and a fourth elastic member. The rod member and the fourth elastic member are mounted in the second buckle. The fourth elastic member drives the rod member to enable a first end of the rod member to protrude from the second buckle. A second end of the rod member is connected to a first end of the cable. A second end of the cable is connected to the pawl. When the first buckle and the second buckle are fastened to each other, the rod member is pushed by the first buckle and retracts into the second buckle to drive the cable to pull the pawl.

In another aspect, the present application further provides a child safety seat. The child safety seat is provided with the safety belt adjustment system as described above.

According to the safety belt adjustment system provided by the present application, after the safety belt is in the buckled state and is tensioned, the retracting shaft is controlled by the drive button to release the safety belt of the predetermined length, and at the same time, a retracting rotation of the retracting shaft is limited by the locking member, so that the safety belt is properly loosened and kept in such loosened state. In this way, on the one hand, the problem of excessive tensioning of the safety belt caused by a large retracting force of the retractor can be prevented. On the other hand, the problem of excessive loosening of the safety belt caused by a small retracting force of the retractor can be prevented. Therefore, a requirement on the retracting force of the retractor is reduced, and comfort and safety of the child during being seated can be achieved.

### BRIEF DESCRIPTION OF THE DRAWINGS

FIG. 1 is a perspective view schematically showing a child safety seat provided with a safety belt adjustment system according to an embodiment of the present application, with seat fabric and a safety belt of the child safety seat being not shown, for ease of illustration.

FIG. 2 is a perspective view schematically showing the safety belt adjustment system according to an embodiment of the present application, with a locking member in an unlocked position and a pawl engaged with a ratchet.

FIG. 3 is a perspective view schematically showing an automatic retracting device, a first locking device, and a second locking device of the safety belt adjustment system according to an embodiment of the present application, with the locking member in the unlocked position and the pawl engaged with the ratchet.

FIG. 4 is a schematical cross-sectional view taken along a line E-E in FIG. 3.

FIG. 5 is a perspective view schematically shows the safety belt adjustment system according to an embodiment of the present application, with the pawl being disengaged from the ratchet by being pulled by a cable, a drive button being not pressed, and the locking member being in the unlocked position.

FIG. 6 is a perspective view schematically showing the automatic retracting device, the first locking device, and the second locking device of the safety belt adjustment system according to an embodiment of the present application, with the pawl being disengaged from the ratchet, the drive button being pressed in place, and the locking member being in a locked position.

FIG. 7 is a perspective view schematically showing the automatic retracting device, the first locking device, and the second locking device of the safety belt adjustment system according to an embodiment of the present application, with the pawl being disengaged from the ratchet, the drive button being resetting, and the locking member being in the locked position.

FIG. 8 is an exploded view schematically showing the automatic retracting device, the first locking device, and the second locking device of the safety belt adjustment system according to an embodiment of the present application.

FIG. 9 is a perspective view schematically showing a pulling mechanism of the safety belt adjustment system according to an embodiment of the present application, and shows an exploded view of a second buckle; and

FIG. 10 is a perspective view schematically showing the pulling mechanism of the safety belt adjustment system according to an embodiment of the present application.

### DETAILED DESCRIPTION OF THE EMBODIMENTS

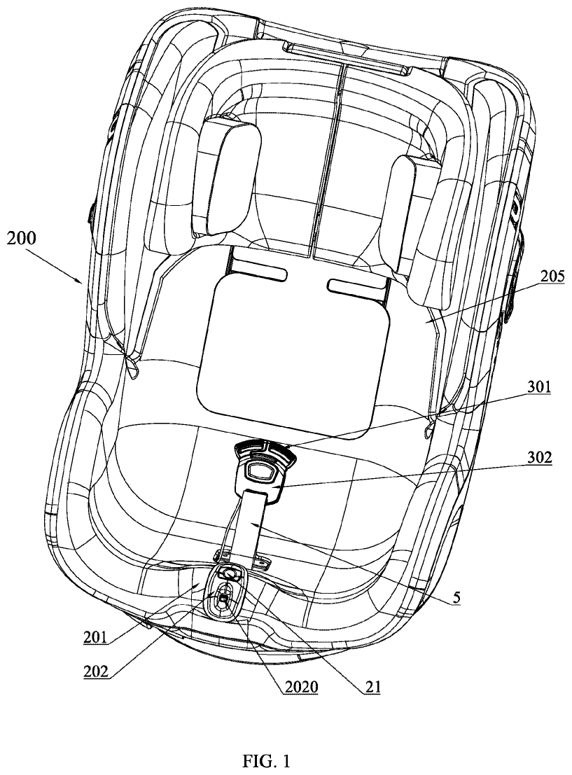

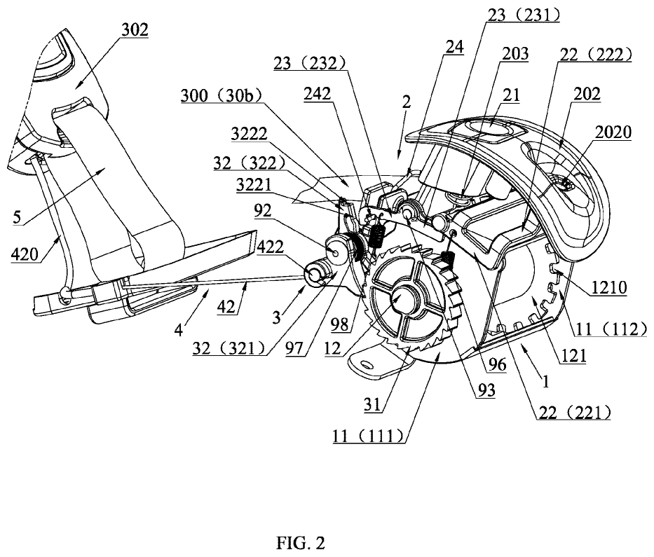

FIG. 2 is a perspective view schematically showing safety belt adjustment system 100 of a child safety seat (hereinafter referred to as the safety belt adjustment system 100 for short), applied to a child safety seat. FIG. 1 schematically shows a child safety seat to which the safety belt adjustment system 100 is applied.

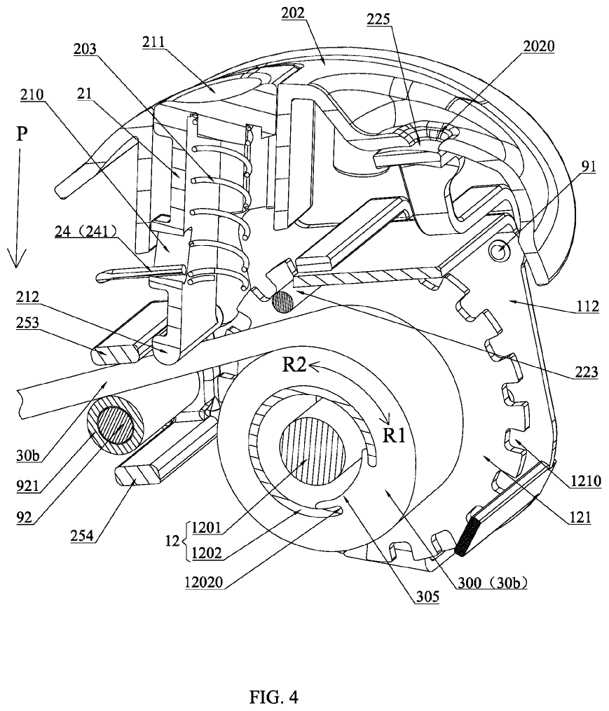

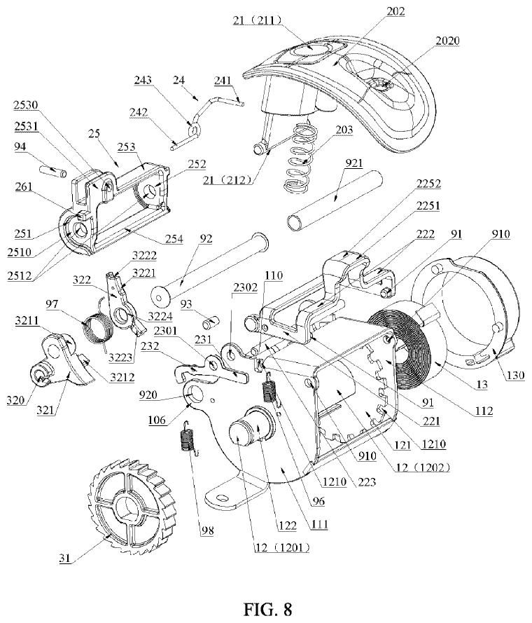

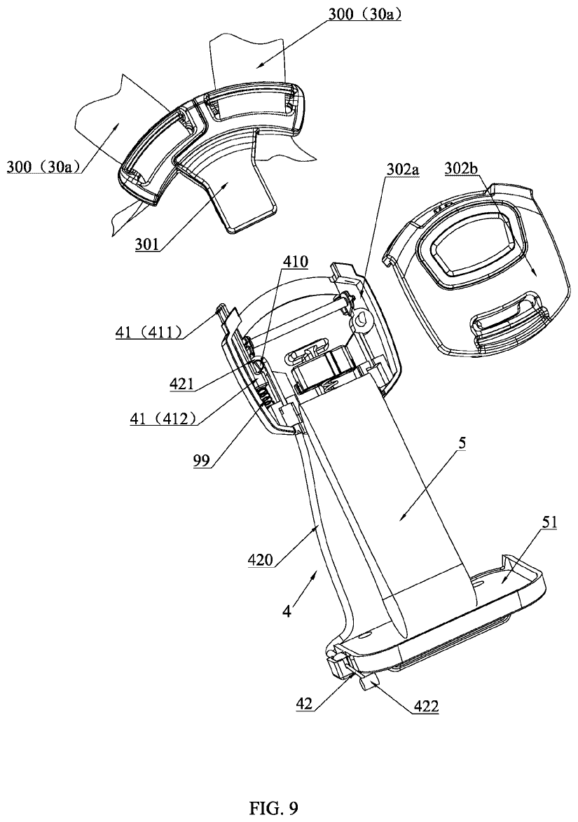

Referring to FIG. 2, the safety belt adjustment system 100 may include an automatic retracting device 1 and a first locking device 2. The automatic retracting device 1 may include a support 11, a retracting shaft 12, and a retractor 13 (see FIG. 8). The retracting shaft 12 and the retractor 13 are mounted on the support 11. The support 11 is adapted to be mounted on a seat housing 200 (see FIG. 1) of the child safety seat. The support 11 may be arranged on a seat portion 201 of the seat housing 200, for example, near a mounting position of a crotch belt 5 on the seat housing 200. The retracting shaft 12 is configured to be connected to a safety belt 300. In combination with the related art, the safety belt 300 generally includes two shoulder belts 30a (see FIG. 9) and an adjustment belt 30b (see FIG. 2). The retracting shaft 12 is specifically connected to the adjustment belt 30b. Two sub-buckles are arranged on the two shoulder belts 30a respectively. The two sub-buckles may be engaged with each other to form a first buckle 301 (see FIG. 1). The crotch belt 5 is mounted on the seat portion 201 through a holder 51 (FIG. 9). The crotch belt 5 is provided with a second buckle 302 (see FIG. 1). In FIG. 9, for ease of illustration, a housing 302a and a housing 302b of the second buckle 302 are engaged with each other. When the first buckle 301 and the second buckle 302 are fastened to each other, it means that the safety belt 300 is in a buckled state. In contrast, when the first buckle 301 withdraws from the second buckle 302, it means that the safety belt 300 is in an unbuckled state. As can be seen from FIG. 4, the adjustment belt 30b of the safety belt 300 is wound around the retracting shaft 12. When the safety belt 300 is in the buckled state, there is no need to pull the adjustment belt 30b, and the retractor 13 of the automatic retracting device 1 automatically drives the retracting shaft 12 to perform a retracting rotation R1 to retract the adjustment belt 30b on the retracting shaft 1, which can easily realize overall tensioning of the safety belt 300 in the buckled state. The retractor 13 may be a coil spring. In this case, when the safety belt 300 is in the unbuckled state, there is no need to operate any unlocking member, and the adjustment belt 30b can be pulled out of the retracting shaft 12 by directly pulling the two shoulder belts 30a, so as to lengthen use lengths of the two shoulder belts 30a in front of a backrest of the child safety seat, thereby facilitating the child to be seated and the safety belt to be fastened.

Referring to FIG. 8, in some embodiments, the support 11 may include, for example, a first sidewall 111 and a second sidewall 112 opposite to the first sidewall 111. A first end 122 of the retracting shaft 12 extends through the first sidewall 111, and a second end (not denoted in the figure) of the retracting shaft 12 extends through the second sidewall 112. The retracting shaft 12 is supported by the first sidewall 111 and the second sidewall 112. A portion of the retracting shaft 12 between the first sidewall 111 and the second sidewall 112 is configured to wind the adjustment belt 30b. The retractor 13 is mounted at the second end of the retracting shaft 12 and is positioned on an outer side of the second sidewall 112. In some embodiments, a protective housing 130 is further mounted on the outer side of the second sidewall 112, and the protective housing 130 is configured to protect the retractor 13.

In some embodiments, the retracting shaft 12 may be integrally formed. In some other embodiments, the retracting shaft 12 may include a plurality of components. For example, referring to FIG. 4, the retracting shaft 12 may include a mandrel 1201 and a cylindrical body 1202. The cylindrical body 1202 is sleeved on the mandrel 1201, and the cylindrical body 1202 is connected to the mandrel 1201 in such a way that the cylindrical body 1202 cannot be rotated relative to the mandrel 1201. Two ends of the mandrel 1201 extends through the first sidewall 111 and the second sidewall 112 respectively. The cylindrical body 1202 is positioned between the first sidewall 111 and the second sidewall 112. The adjustment belt 30b is wound around the cylindrical body 1202. In some embodiments, the cylindrical body 1202 is provided with a notch 12020, and the adjustment belt 30b includes a portion 305 capable of being snapped into the notch 12020.

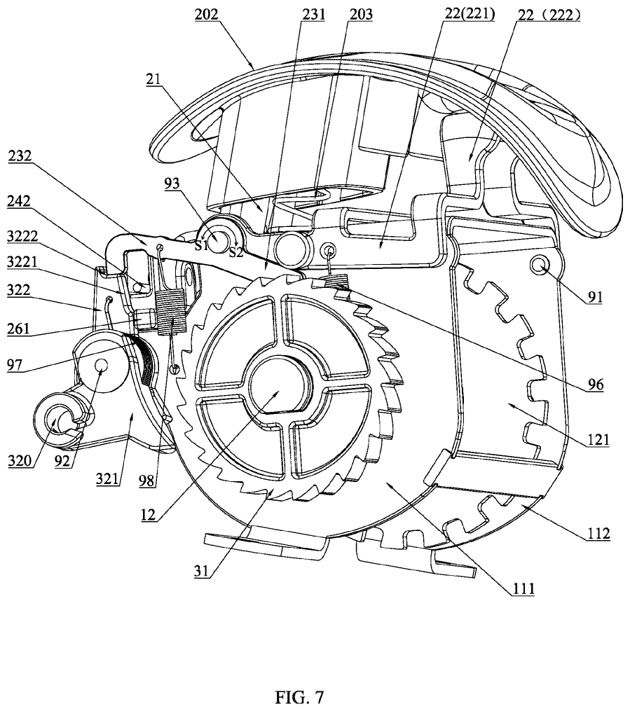

Referring to FIG. 2 and FIGS. 4 to 8, the first locking device 2 may include a drive button 21 and a locking member 22. The drive button 21 is adapted to be mounted on the seat housing 200 and is configured to drive the retracting shaft 12 to perform a release rotation R2 for releasing the safety belt 300. The locking member 22 has a locked position (FIG. 7) and an unlocked position (FIG. 2). In the locked position, the locking member 22 locks the retracting rotation RI and the release rotation R2 of the retracting shaft 12. In the unlocked position, the locking member 22 unlocks the retracting shaft 12, and the locking member 22 does not lock the retracting rotation R1 and the release rotation R2 of the retracting shaft 12.

Referring to FIGS. 2, 7, and 9, a position of the locking member 22 is related to a state of the safety belt 300 and an operation of the drive button 21. Specifically, when the safety belt 300 is in the unbuckled state, the locking member 22 is in the unlocked position. In this case, the locking member 22 does not limit the rotation of the retracting shaft 12, and the user can pull the shoulder belt 30a to pull the adjustment belt 30b out of the retracting shaft 12, so that the use length of the shoulder belt 30a becomes long. In some embodiments, when the safety belt 300 is in the unbuckled state, the adjustment belt 30b may alternatively be further wound around the retracting shaft 12 due to the existence of the retractor 13. After the safety belt 300 is switched from the unbuckled state to the buckled state, the retractor 13 automatically drives the retracting shaft 12 to retract the adjustment belt 30b, and the safety belt 300 is entirely tensioned. After the safety belt 300 is entirely tensioned, the user may apply a pressing force P (see FIG. 4) to the drive button 21, and the drive button 21 drives the retracting shaft 12 to perform the release rotation R2, so that the retracting shaft 12 releases the safety belt 30b of a predetermined length and the locking member 22 is switched from the unlocked position to the locked position.

The drive button 21 controls the retracting shaft 12 to release the safety belt 30b of the predetermined length, and at the same time, the locking member 22 in the locked position limits the retracting rotation R1 and the release rotation R2 of the retracting shaft 12, so that the safety belt 300 is properly loosened and kept in such loosened state. In this way, on the one hand, the problem of discomfort of the child due to excessive tensioning of the safety belt caused by a large retracting force of the retractor 13 can be prevented. On the other hand, the problem that the safety belt cannot reliably restrain the child due to excessive loosening of the safety belt 300 caused by a small retracting force of the retractor 13 can be prevented. Therefore, a requirement on the retracting force of the retractor 13 is reduced, and comfort and safety of the child during being seated are balanced.

Referring to FIGS. 1 and 4, the seat housing 200 includes a seat portion 201 and a backrest portion 205. The seat portion 201 includes a cavity (not shown in the figure) for accommodating the support 11. A cover 202 may be mounted on the top of the cavity. The drive button 21 is mounted on the cover 202. In addition, a reset spring 203 may be mounted between the cover 202 and the drive button 21. When the pressing force applied to the drive button is removed, the drive button 21 may be reset, driven by a reset spring 203.

Referring to FIG. 4, the drive button 21 may include a pressing end 211 and an abutting end 212 opposite to the pressing end 211. After the safety belt 300 is in the buckled state and is tensioned by the automatic retracting device 1, the pressing force P is applied to the pressing end of the drive button 21, such that the abutting end 212 moves down and presses against a portion of the adjustment belt 30b not wound around the retracting shaft 12. The retracting shaft 12 is driven to perform the release rotation while the adjustment belt 30b is deformed by force. It can be understood that the retracting shaft 12 may be controlled to release a certain length of the adjustment belt by controlling a stroke of the drive button 21. In some embodiments, the first locking device 2 is configured as follows: when the safety belt 300 is switched from the unbuckled state to the buckled state, the drive button 21 is firstly pressed in place such that the retracting shaft 12 releases the adjustment belt 30b of a predetermined length and the locking member 22 reaches the locked position, and then the locking member 22 is still held in the locked position even if the pressing force P is removed to reset the drive button 21, so as to prevent retraction of the adjustment belt 30b of the predetermined length that has been released. When the safety belt 300 is switched from the buckled state to the unbuckled state, the locking member 22 is automatically switched from the locked position to the unlocked position, so as to release the limitation on the rotation of the retracting shaft 12. It is to be noted that, although the drive button 21 presses the adjustment belt 30b to enable the retracting shaft 12 to perform the release rotation R2, in some embodiments, the drive button 21 may, for example, directly drive the retracting shaft 12 to perform the release rotation R2.

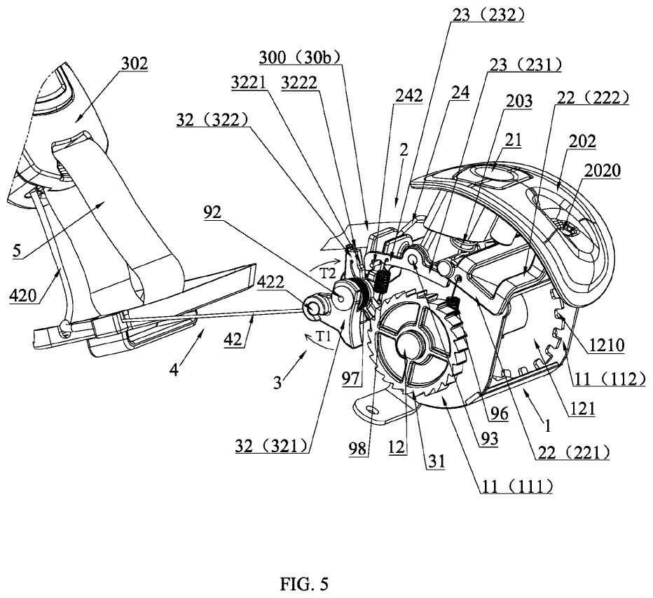

Referring to FIG. 2 and FIGS. 5 to 7, in some embodiments, the safety belt adjustment system 100 may further include a second locking device 3. The second locking device 3 is configured to lock the retracting rotation R1 of the retracting shaft 12 when the safety belt is in the unbuckled state. The second locking device 3 may include a ratchet 31, a pawl 32, and a second elastic element 97. The ratchet 31 is connected to the retracting shaft 12 (more specifically, the mandrel 1201) and rotates along with the retracting shaft 12. The ratchet 31 is, for example, connected to the first end 122 of the retracting shaft 12 and positioned on an outer side of the first sidewall 111. The pawl 32 is pivotally connected to the support 11 through a second pivot 92. In some embodiments, the first sidewall 111 and the second sidewall 112 may each be provided with a mounting hole 920 (FIG. 8), and the second pivot 92 is mounted in the mounting hole 920. Referring to FIG. 5, when the safety belt 300 is switched from the unbuckled state to the buckled state, the pawl 32 is pulled by the cable 42 and rotates around the second pivot 92, until the pawl 32 is disengaged from the ratchet 31. In this case, the second locking device 3 does not limit the rotation of the retracting shaft 12. When the drive button 21 is not pressed, the locking member 22 is in the unlocked position, and the retracting shaft 12 can automatically retract the adjustment belt 30b under the action of the retractor 13, so that the safety belt 300 is tensioned. In contrast, when the safety belt 300 is switched from the buckled state to the unbuckled state, the pawl 32 is driven by the second elastic element 97 to rotate around the second pivot 92, until the pawl 32 is engaged with the ratchet 31. The pawl 32 and the ratchet 31 are engaged with each other such that the retracting rotation R1 of the retracting shaft 12 can be limited but the release rotation R2 of the retracting shaft 12 is not limited, which helps to stabilize the length by which the adjustment belt 30b is pulled out.

Referring to FIG. 4, the second pivot 92 supports the adjustment belt 30b at a position near the retracting shaft 12, the abutting end 212 of the drive button 21 is positioned between the retracting shaft 12 and the second pivot 92, and the drive button 21 is adapted to press the adjustment belt 30b between the retracting shaft 12 and the second pivot 92. In this way, the deformation of the adjustment belt 30b can effectively act on the retracting shaft 12 to enable the retracting shaft 12 to perform the release rotation R2.

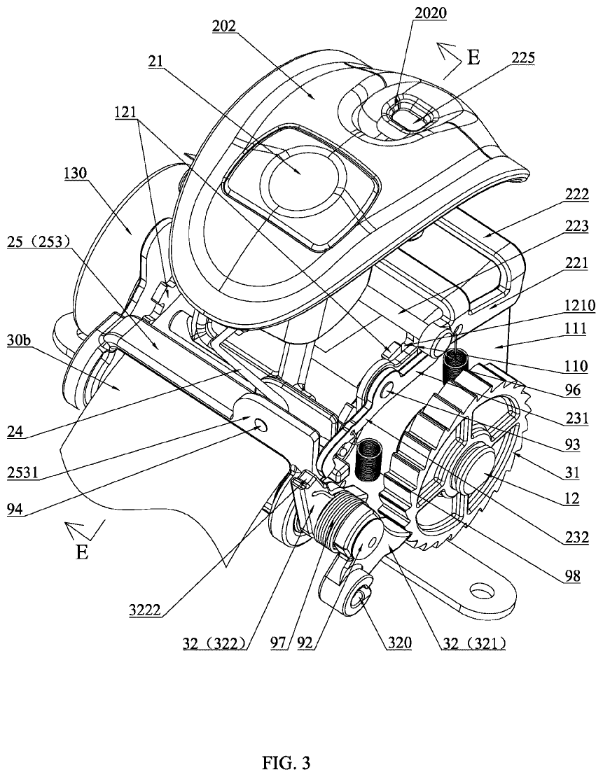

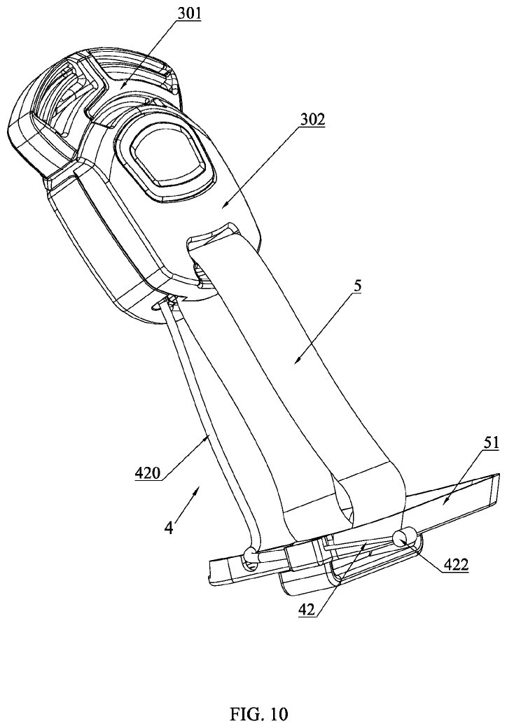

In some embodiments, the pawl 32 may be disengaged from the ratchet 31 under the action of a pulling mechanism 4. Referring to FIGS. 2, 9, and 10, the pulling mechanism 4 may include a rod member 41, the cable 42, and a fourth elastic member 99. The rod member 41 and the fourth elastic member 99 are mounted in the second buckle 302. The rod member 41 may move backward and forward along a direction in which the first buckle 301 is engaged or disengaged. The fourth elastic element 99 may be a spring. The fourth elastic element 99 drives the rod member 41 to enable a first end 411 of the rod member 41 to protrude from the second buckle 302. A second end 412 of the rod member 41 is connected to a first end 421 of the cable 42. The cable 42 is wound around a convex portion 410 of the rod member 41 in the second buckle 302. A second end 422 of the cable 42 is connected to a mounting hole 320 (see FIG. 3) of the pawl 32. The cable 42 may be a steel wire. A protective sleeve 420 may be sleeved on at least part of the cable 42. When the first buckle 301 is inserted into the second buckle 302 to be fastened with the second buckle 302, the rod member 41 is pushed by the first buckle 301 and retracts into the second buckle 302, thereby driving the cable 42 to pull the pawl 32, so that the pawl 32 rotates around the second pivot 92 to a position where the pawl 32 is separated from the ratchet 31. When the first buckle 301 is withdrawn from the second buckle 302 and separated from the second buckle 302, the fourth elastic element 99 may push the rod member 41 outwards, and the pawl 32 rotates around the second pivot 92 under the action of the second elastic element 97 to be engaged with the ratchet 31. It can be understood that the configuration of the pulling mechanism 4 that drives the pawl 32 to be disengaged from the ratchet 31 is not limited to the above embodiments.

As can be seen from the above, after the safety belt 300 is in the buckled state and the automatic retracting device 1 has retracted the adjustment belt 30b and tensioned the entire safety belt 300, the user releases the adjustment belt 30b of a predetermined length, and enables the locking member 22 to reach the locked position, by pressing the drive button 21, so as to achieve an effect of adjusting the tightness of the safety belt 300. When the safety belt 300 is in the unbuckled state, the locking member 22 is switched to the unlocked position, so as not to affect normal release of the safety belt 300. That is, there is no need to operate any unlocking member, and the use lengths of the two shoulder belts 30a can be lengthened by directly pulling the two shoulder belts 30a, thereby facilitating the child to being seated and the safety belt to be fastened. In addition, when the safety belt 300 is in the buckled state, the pawl 32 is disengaged from the ratchet 31. When the safety belt is in the unbuckled state, the pawl 32 is engaged with the ratchet 31. In some embodiments, a change in the position of the locking member 22 may be associated with a change in the position of the pawl 32, so that, when the seat belt 300 is in the buckled state, the locking member 22 is held in the locked position by means of the pawl 32, and when the seat belt 300 is in the unbuckled state, the locking member 22 is automatically switched to the unlocked position as the pawl 32 moves. Referring to FIG. 7, in some embodiments, when the pawl 32 is disengaged from the ratchet 31 and the locking member 22 is switched to the locked position, the pawl 32 can act on the locking member 22 to hold the locking member 22 in the locked position. Referring to FIG. 2, when the pawl 32 is engaged with the ratchet 31, the pawl 32 is separated from the locking member 22, the pawl 32 does not act on the locking member 22, and the locking member 22 automatically returns to the unlocked position. An exemplary manner in which the change in the position of the locking member 22 is associated with the change in the position of the pawl 32 is exemplified below. Certainly, the manner in which the change in the position of the locking member 22 is associated with the change in the position of the pawl 32 is not limited to the embodiment below.

Referring to FIGS. 2, 3, and 5 to 8, the locking member 22 may include a first supporting portion 221 and a lock pin portion 223. The first supporting portion 211 is pivotally connected to the first sidewall 111 and the second sidewall 112 of the support 11 through a first pivot 91. The lock pin portion 223 is connected to the first supporting portion 221. Referring to FIG. 8, the first pivot 91 includes two protruding posts protruding from the first supporting portion 221 and extending in a direction facing each other. The two protruding posts are mounted in the mounting holes 910 of the first sidewall 111 and the second sidewall 112 respectively. Certainly, in some embodiments, the first pivot 91 may alternatively be a long shaft extending through the mounting holes 910 of the first sidewall 111 and the second sidewall 112. The first pivot 91 is parallel to the retracting shaft 12, and the lock pin portion 223 may also be parallel to the retracting shaft 12. When the locking member 22 rotates around the first pivot 91 to switch between the locked position and the unlocked position, bidirectional rotation (the retracting rotation R1 and the release rotation R2) of the retracting shaft 12 is locked or unlocked by the lock pin portion 223.

Referring to FIG. 8, in some embodiments, a length of the lock pin portion 223 spans the first sidewall 111 and the second sidewall 112. The first sidewall 111 and the second sidewall 112 of the support 11 may each be provided with a first groove 110. Two locking gears 121 may be mounted on the retracting shaft 12. One of the two locking gears 121 is positioned on an inner side of the first sidewall 111, and the other of the two locking gears 121 is positioned on an inner side of the second sidewall 112. Each of the two locking gears 121 is connected to the retracting shaft 12 in such a way that the locking gear 121 cannot be rotated relative to the retracting shaft 12. Referring to FIGS. 4 and 8, in some embodiments, the two locking gears 121 are mounted at two ends of the cylindrical body 1202 respectively. A second groove 1210 is formed between every two adjacent teeth of each of the two locking gear 121. When the locking member 22 is in the locked position, the lock pin portion 223 is snapped into the first groove 110 and the second groove 1210 aligned with the first groove 110. In contrast, when the locking member 22 is in the unlocked position, the lock pin portion 223 is separated from the first groove 110 and the second groove 1210. In some embodiments, the length of the lock pin portion 223 may span, for example, only the first sidewall 111. In this case, only the first sidewall 111 may be provided with the first groove 110, and correspondingly, only one locking gear 121 is mounted on the inner side of the first sidewall 111. In this way, when the locking member 22 is rotated, the lock pin portion 223 can also lock or unlock the bidirectional rotation of the retracting shaft 12.

Referring to FIGS. 2 to 8, the first locking device 2 may further include a first elastic member 96, a third elastic member 98, a pivot arm 23, and a pushing member 24.

The first elastic member 96 is, for example, a spring connected between the first supporting portion 221 and the first sidewall 111 of the support 11, which may be a tension spring, and is configured to apply a first torque to the locking member 22 to rotate the locking member 22 toward the locked position. In other embodiments, the first elastic member 96 may alternatively be a torsion spring.

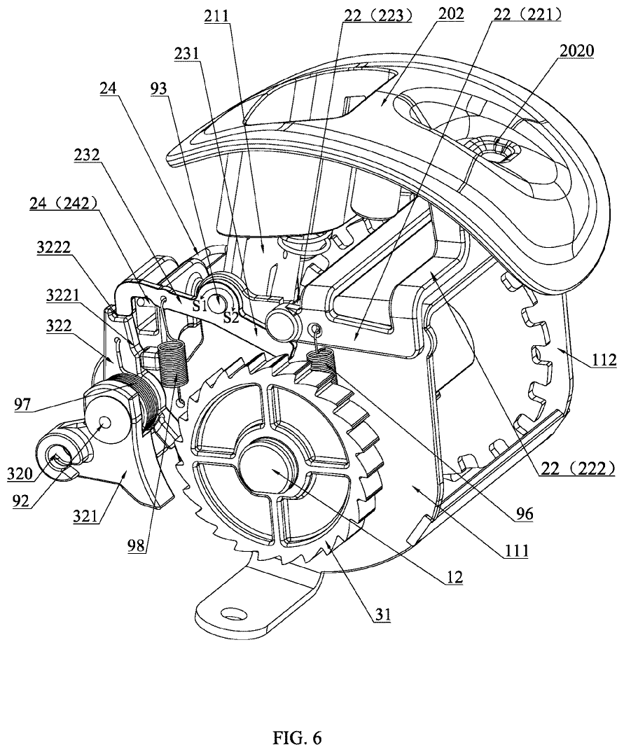

Referring to FIGS. 2 and 5 to 8, a middle portion of the pivot arm 23 is pivotally connected to the first sidewall 111 of the support 11 through a third pivot 93. The third pivot 93 divides the pivot arm 23 into a first half arm 231 and a second half arm 232. The pivot arm 23 is positioned on an outer side of the first sidewall 111. The third pivot 93 is parallel to the first pivot 91. The first half arm 231 of the pivot arm 23 abuts against the first supporting portion 221, and the second half arm 232 is closer to the pawl 32 than the first half arm 231. The first sidewall 111 is provided with a mounting hole 2302 for mounting the third pivot 93. The pivot arm 23 is provided with a mounting hole 2301 for mounting the third pivot 93. The third elastic member 98 is, for example, a spring connected between the pivot arm 23 and the first sidewall 111 of the support 11, which may be a tension spring, and is configured to drive the pivot arm 23 to rotate around the third pivot 93 in a first direction S1 (as shown in FIGS. 6 and 7), so that the first half arm 231 applies a second torque to the first supporting portion 221 to rotate the locking member 22 toward the unlocked position. A value of the second torque is greater than that of the foregoing first torque, so as to hold the locking member 22 in the unlocked position. In some embodiments, the third elastic member 98 may alternatively be a torsion spring sleeved on the third pivot 93.

Referring to FIGS. 3, 4, and 6, the pushing member 24 is connected to the drive button 21. The pushing member 24 pushes the second half arm 232 of the pivot arm 23 when the drive button 21 is subjected to the pressing force P, so that the pivot arm 23 overcomes the second torque and rotates around the third pivot 93 in a second direction S2 (as shown in FIGS. 6 and 7), until the second half arm 232 abuts against the pawl 32. In this case, the pushing member 24 does not drive the pivot arm 23 to rotate in the second direction S2, but uses the abutment of the pawl 32 against the pivot arm 23 to limit the rotation of the pivot arm 23 in the first direction S1, so that the pivot arm 23 is in a stable state, where the second direction S2 is opposite to the first direction S1. It can be understood that, when the pivot arm 23 rotates in the second direction S2, the locking member 22 rotates toward the locked position under the action of the first elastic member 96. In some embodiments, after the drive button 21 is pressed in place, the second half arm 232 abuts against the pawl 32, and the locking member 22 reaches the locked position.

Referring to FIGS. 3 and 8, the first locking device 2 may further include a mounting rack 25. The mounting rack 25 is connected to the support 11, and a middle portion of the pushing member 24 is connected to the mounting rack 25. More specifically, the mounting rack 25 is connected to the support 11 through the second pivot 92, and a rotation stopping structure configured to limit rotation of the mounting rack 25 around the second pivot 92 is arranged between the mounting rack 25 and the support 11. The rotation stopping structure may include two limiting recesses 2510 and two connecting lugs 106. The two connecting lugs 106 are arranged on the first sidewall 111 and the second sidewall 112 of the support 11 respectively. The two limiting recesses 2510 are arranged on the mounting rack 25. The two connecting lugs 106 are snapped into the two limiting recesses 2510. The second pivot 92 extends through each of the limiting recesses 2510 and each of the connecting lugs 106. Abutment of each of the connecting lugs 106 against the corresponding limiting recess 2510 limits the rotation of the mounting rack 25 around the second pivot 92. It can be understood that the implementation of the rotation stopping structure is not limited to the above embodiments.

Referring to FIG. 8, the middle portion of the pushing member 24 is specifically pivotally connected to the mounting rack 25 through a fourth pivot 94. The fourth pivot 94 is perpendicular to the retracting shaft 12. The mounting rack 25 is provided with a mounting hole 2530 in which the fourth pivot 94 is mounted. A first end 241 of the pushing member 24 is bent and then connected to the drive button 21. For example, the drive button 21 is provided with an elongated hole 210 (see FIG. 4). The first end 241 of the pushing member 24 is inserted into the elongated hole 210. When the drive button 21 is subjected to the pressing force P, the drive button 21 drives the pushing member 24 to rotate around the fourth pivot 94, so that a second end 242 of the pushing member 24 is raised up to push the second half arm 232 to rotate. Referring to FIGS. 3 and 8, the pushing member 24 may be made of an elastically deformable metal rod, and a middle portion of the metal rod forms a ring 243 capable of being wound around the fourth pivot 94. Certainly, the implementation of the pushing member 24 is not limited to the above embodiment.

Referring to FIG. 8, the mounting rack 25 may include a first frame 251 and a second frame 252 arranged opposite to each other, and a third frame 253 and a fourth frame 254 that are connected between the first frame 251 and the second frame 252. The fourth frame 254 is opposite to the third frame 253. The first frame 251 is positioned on the inner side of the first sidewall 111, and the second frame 252 is positioned on the inner side of the second sidewall 112. The second pivot 92 extends through mounting holes 2512 of the first frame 251 and the second frame 252. The above limit recesses 2510 may be arranged on the first frame 251 and the second frame 252. The third frame 253 may be provided with an outwardly protruding hinge base 2531. The mounting hole 2530 is arranged in the hinged base 2531. The fourth pivot 94 is connected to the hinge base 2531 through the mounting hole 2530. Referring to FIG. 4, the adjustment belt 30b of the safety belt 300 passes between the second pivot 92 and the third frame 253, and the safety belt 300 is limited in a long and narrow space enclosed by the first frame 251, the second frame 252, the third frame 253 and the second pivot 92, which can prevent the safety belt 300 from not being positioned in a pressing trajectory of the drive button 21 due to arbitrary sliding on the second pivot 92.

Referring to FIG. 4, in some embodiments, a shaft sleeve 921 may be further sleeved on the second pivot 92, and the shaft sleeve 921 is positioned between the first frame 251 and the second frame 252 and is configured for contacting with the adjustment belt 30b. The shaft sleeve 921 may rotate relative to an axis of the second pivot 92, so that a frictional force between the safety belt and the shaft sleeve 921 can be reduced.

Referring to FIG. 7, the pawl 32 of the second locking device 3 may include a claw portion 321 and an abutting portion 322. The claw portion 321 is connected to the cable 42 and configured to be engaged with the ratchet 31. An extending direction of the abutting portion 322 is opposite to an extending direction of the claw portion 321. The abutting portion 322 is configured to abut against the second half arm 232 to limit rotation of the pivot arm 23 in the first direction S1, so as to hold the locking member 22 in the locked position.

Referring to FIG. 2, the abutting portion 322 includes a side contact wall 3221 and a limiting step 3222 at an end portion of the side contact wall 3221. Referring to FIG. 5, when the safety belt 300 is switched from the unbuckled state to the buckled state, the claw portion 321 of the pawl 32 rotates in a direction Tl away from the ratchet 31 and is separated from the ratchet 31, and the abutting portion 322 rotates in a direction T2 approaching the second half arm 232 until the side contact wall 3221 presses against an end portion of the second half arm 232. When the locking member 22 is in the unlocked position, the retractor 13 drives the retracting shaft 12 to retract the adjustment belt 30b, so that the safety belt 300 is entirely tensioned. Then, the user presses the drive button 21, and after the drive button 21 is pressed in place, the retracting shaft 12 releases the adjustment belt 30b of a predetermined length. Referring to FIG. 6, the drive button 21, when pressed, drives the pushing member 24 to rotate around the fourth pivot 94, the second end 242 of the pushing member 24 pushes the second half arm 232 to rotate in the second direction S2, and the end portion of the second half arm 232 is in sliding fit with the side contact wall 3221 and moves upward. Still referring to FIG. 6, after the drive button 21 is pressed in place, the second end 242 of the pushing member 24 pushes the end portion of the second half arm 232 to pass over the side contact wall 3221, the abutting portion 322 may approach the end portion of the second half arm 232, and then the end portion of the second half arm 232 abuts against the limiting step 3222. In this case, the pivot arm 23 is balanced against the abutting portion 322. At the same time, the first half arm 231 of the pivot arm 23 does not limit the movement of the locking member 22 toward the locked position, and the locking member 22 is driven by the first elastic member 96 to move to the locked position and is held in the locked position. Then, referring to FIG. 7, the pressing force P applied to the drive button 21 is removed, the drive button 21 is reset, and the pushing member 24 is reset. When the safety belt 300 is switched from the buckled state to the unbuckled state, the claw portion 321 of the pawl 32 moves in a direction of being engaged with the ratchet 31, the abutting portion 322 is separated from the second half arm 232, and the third elastic element 98 drives the second half arm 232 to rotate in the first direction S1 and drives, through the first half arm 231, the locking member 22 to the unlocked position.

Referring to FIG. 8, in some embodiments, the claw portion 321 and the abutting portion 322 are sperate parts, and both the claw portion 321 and the abutting portion 322 are sleeved on the second pivot 92. The second elastic element 97 is a torsion spring. The torsion spring is sleeved on the second pivot 92 and is arranged between the claw portion 321 and the abutting portion 322. Two spring arms of the torsion spring are respectively connected to the claw portion 321 and the abutting portion 322. The torsion spring as the second elastic element 97 is configured to bias the claw portion 321 in a direction of being engaged with the ratchet 31 and to bias the abutting portion 322 in a direction away from the pivot arm 23. After the safety belt is switched to the buckled state, the claw portion 321 is pulled by the cable 42 to overcome a biasing force of the torsion spring, so that the claw portion 321 moves away from the ratchet 31 and remains disengaged from the ratchet 31, and the abutting portion 322 approaches the pivot arm 23 (the side contact wall 3221 of the abutting portion 322 abuts against the end portion of the second half arm 232 of the pivot arm 23). As described above, after the drive button 21 is pressed, the second half arm 232 of the pivot arm 23 is raised up, and the abutting portion 322 may continue to approach the pivot arm 23 (the side contact wall 3221 of the abutting portion 322 is in sliding fit with the end portion of the second half arm 232 of the pivot arm 23) and move to be on a path of downward rotation of the second half-arm 232 of the pivot arm 23. After the drive button 21 is pressed in place, the limiting step 3222 of the abutting portion 322 abuts against the pivot arm 23, so that the second half-arm 232 of the pivot arm 23 cannot rotate downward. In this case, the first half arm 231 of the pivot arm 23 moves down, and the locking member 22 completes locking under the action of the first elastic member 96.

Referring to FIG. 8, in some embodiments, the claw portion 321 includes a sleeve portion 3211. The sleeve portion 3211 is sleeved on the second pivot 92. Both the second elastic element 97 and the abutting portion 322 are sleeved on the sleeve portion 3211. More specifically, the abutting portion 322 may include an annular pivot portion 3224. The pivot portion 3224 is sleeved on the sleeve portion 3211. In addition, a first protrusion 3212 may be arranged on the claw portion 321. The first protrusion 3212 extends toward the abutting portion 322. A second protrusion 3223 may be arranged on the pivot portion 3224 of the abutting portion 322. The second protrusion 3223 abuts against the first protrusion 3212 under the action of the second elastic element 97. A third protrusion 261 may be arranged on the mounting rack 25 (see FIG. 7). The third protrusion 261 may abut against the side contact wall 3221 of the abutting portion 322 to limit the abutting portion 322 from getting too close to the ratchet 31.

Referring to FIGS. 2, 3, 5, and 8 again, the seat housing 200 may be provided with a display window 2020. More specifically, the display window 2020 is arranged on, for example, the cover 202. The locking member 22 may further include a second supporting portion 222. The second supporting portion 222 is connected to the first supporting portion 221. An indicator 225 is arranged on the second supporting portion 222. The indicator 225 includes a first indication region 2251 and a second indication region 2252. When the locking member 22 is in the locked position, the first indication region 2251 of the indicator 225 faces the display window 2020. In contrast, when the locking member 22 is in the unlocked position, the second indication region 2252 of the indicator 225 faces the display window 2020. In this way, a position state of the locking member 22 can be easily known by observing display of the indicator 225 at the display window 2020, so as to prompt the user to press the drive button 21 as required. The first indication region 2251 is displayed in, for example, green, and the second indication region 2252 is displayed in, for example, red.

In other embodiments, the seat housing 200 may be provided with a reminder device (not shown in the figure). The reminder device is configured to remind the position state of the locking member 22. The reminder device may be mounted at the display window 2020 or another suitable position, which may be a display screen and/or an indicator light and/or a buzzer, etc., and is configured to prompt the user to press the drive button through a sound reminder and/or a display reminder. For example, after the first buckle 301 and the second buckle 302 are fastened to each other, the reminder device can always emit a sound/light reminder if the user does not press the drive button 21. After the user presses the drive button 21, the sound/light reminder stops. When the reminder device is mounted on the cover 202, the reminder may be turned off through movement of the second supporting portion 222. In addition, a sign may be pasted on the seat housing 200 to prompt the user to press the drive button 21 after the first buckle 301 and the second buckle 302 are fastened to each other.

In some embodiments, the reminder device is, for example, a display screen. For example, after the first buckle 301 and the second buckle 302 are fastened to each other, red is displayed on the display screen to remind the user to press the drive button 21. After the user presses the drive button 21, green is displayed on the display screen. In some embodiments, an image depicting an action of a finger pressing the drive button 21 may be displayed on the display screen to remind the user to press the drive button 21. An embodiment of the present application further provides a child safety seat, which is provided with the safety belt adjustment system 100 as described above.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only illustrate several implementations of the present application, and their description is specific and detailed, but cannot therefore be understood as a limitation on the patent scope of the present application. It should be noted that those of ordinary skill in the art may further make variants and improvements without departing from the conception of the present application, and these all fall within the protection scope of the present application. Therefore, the patent protection scope of the present application should be subject to the appended claims.

1. A safety belt adjustment system for a child safety seat, comprising:
an automatic retracting device comprising a retracting shaft and a retractor, the retracting shaft being configured to be connected to a safety belt, the retractor driving the retracting shaft to perform a retracting rotation for retracting the safety belt, so as to tension the safety belt in a buckled state; and
a first locking device comprising a drive button and a locking member; the drive button being configured to drive the retracting shaft to perform a release rotation for releasing the safety belt; the locking member having a locked position, and wherein in the locked position, the locking member locks the retracting rotation of the retracting shaft.

2. The safety belt adjustment system according to claim 1, wherein the locking member further locks the release rotation of the retracting shaft in the locked position, and the locking member has an unlocked position for unlocking the retracting shaft; and
when the safety belt is in an unbuckled state, the locking member is in the unlocked position; and after the safety belt is in the buckled state and is tensioned by the automatic retracting device, a pressing force is applied to the drive button to drive the retracting shaft to perform the release rotation, so that the locking member is switched from the unlocked position to the locked position while the retracting shaft releases the safety belt of a predetermined length.

3. (canceled)

4. The safety belt adjustment system according to claim 2, wherein the drive button comprises a pressing end and an abutting end opposite to the pressing end; and when the drive button is subjected to the pressing force, the abutting end presses against a portion of the safety belt not wound around the retracting shaft, and the safety belt is deformed subjected to a force applied by the abutting end and drives the retracting shaft to perform the release rotation.

5. The safety belt adjustment system according to claim 4, wherein after the locking member is switched from the unlocked position to the locked position, the pressing force is removed, the drive button is reset, and the locking member is held in the locked position; and
when the safety belt is switched from the buckled state to the unbuckled state, the locking member is switched from the locked position to the unlocked position.

6. The safety belt adjustment system according to claim 5, further comprising a second locking device, the second locking device comprising a ratchet, a pawl, and a second elastic element;
wherein the ratchet is connected to the retracting shaft;
the automatic retracting device further comprises a support, the support being adapted to be mounted on a seat housing of the child safety seat, and the retracting shaft and the retractor are mounted on the support; and the drive button is adapted to be mounted on the seat housing;
the pawl is pivotally connected to the support through a second pivot and connected to a cable; when the safety belt is switched from the unbuckled state to the buckled state, the pawl is pulled by the cable and is rotated to be disengaged from the ratchet; and when the safety belt is switched from the buckled state to the unbuckled state, the pawl is driven by the second elastic element and is rotated to be engaged with the ratchet, thereby locking the retracting rotation of the retracting shaft; and
when the pawl is disengaged from the ratchet and the locking member is switched to the locked position, the pawl is capable of acting on the locking member to hold the locking member in the locked position; and when the pawl is engaged with the ratchet, the locking member is allowed to return to the unlocked position.

7. The safety belt adjustment system according to claim 6, wherein the second pivot supports the safety belt outside the retracting shaft, and the abutting end of the drive button is positioned between the retracting shaft and the second pivot.

8. The safety belt adjustment system according to claim 7, wherein the locking member comprises a first supporting portion and a lock pin portion, the first supporting portion being pivotally connected to the support through a first pivot, the first pivot being parallel to the retracting shaft, the lock pin portion being connected to the first supporting portion; and the locking member rotates around the first pivot to switch between the locked position and the unlocked position;
the support is provided with a first groove; and a locking gear is mounted on the retracting shaft, and a second groove is formed between every two adjacent teeth of the locking gear; and
when the locking member is in the locked position, the lock pin portion is snapped into the first groove and the second groove aligned with the first groove, and when the locking member is in the unlocked position, the lock pin portion is separated from the first groove and the second groove.

9. The safety belt adjustment system according to claim 8, wherein the first locking device further comprises a first elastic member, a third elastic member, a pivot arm, and a pushing member;
wherein the first elastic member applies a first torque to the locking member to rotate the locking member toward the locked position;
a middle portion of the pivot arm is pivotally connected to the support through a third pivot, the third pivot being parallel to the first pivot, and a first half arm of the pivot arm abuts against the first supporting portion;
the third elastic member drives the pivot arm to rotate around the third pivot in a first direction, so that the first half arm applies a second torque to the first supporting portion to rotate the locking member toward the unlocked position; and
the pushing member is connected to the drive button, and the pushing member pushes a second half arm of the pivot arm when the drive button is subjected to the pressing force, so that the pivot arm rotates around the third pivot in a second direction, until the second half arm abuts against the pawl, the second direction being opposite to the first direction.

10. The safety belt adjustment system according to claim 9, wherein the pawl comprises a claw portion and an abutting portion;
wherein the claw portion is connected to the cable and configured to be engaged with the ratchet; and
an extending direction of the abutting portion is opposite to an extending direction of the claw portion, and the abutting portion is configured to abut against the second half arm to limit rotation of the pivot arm in the first direction.

11. The safety belt adjustment system according to claim 10, wherein the abutting portion comprises a side contact wall and a limiting step at an end portion of the side contact wall; and
when the pawl is separated from the ratchet and the pivot arm rotates in the second direction, an end portion of the second half arm abuts against the side contact wall, until the end portion of the second half arm passes over the side contact wall and abuts against the limiting step.

12. (canceled)

13. The safety belt adjustment system according to claim 9, wherein the first locking device further comprises a mounting rack connected to the support;
a middle portion of the pushing member is pivotally connected to the mounting rack through a fourth pivot, the fourth pivot being perpendicular to the retracting shaft; and
a first end of the pushing member is bent and connected to the drive button, and when the drive button is subjected to the pressing force, the drive button drives the pushing member to rotate around the fourth pivot, so that a second end of the pushing member pushes the second half arm.

14. (canceled)

15. The safety belt adjustment system according to claim 13, wherein the mounting rack is connected to the support through the second pivot, and a rotation stopping structure configured to limit rotation of the mounting rack around the second pivot is arranged between the mounting rack and the support.

16. (canceled)

17. The safety belt adjustment system according to claim 15, wherein the mounting rack comprises a first frame and a second frame arranged opposite to each other, and a third frame connected between the first frame and the second frame; and
the second pivot extends through the first frame and the second frame, and the safety belt passes between the second pivot and the third frame; and the third frame is provided with an outwardly protruding hinge base, and the fourth pivot is connected to the hinge base.

18. The safety belt adjustment system according to claim 17, wherein the rotation stopping structure comprises limiting recesses arranged on the first frame and the second frame, and connecting lugs arranged on the support, the connecting lugs being snapped into the limiting recesses respectively, and the second pivot extends through the limiting recesses and the connecting lugs.

19. The safety belt adjustment system according to claim 8, wherein the seat housing is provided with a display window;
the locking member further comprises a second supporting portion, wherein the second supporting portion is connected to the first supporting portion; and an indicator is arranged on the second supporting portion, and the indicator comprises a first indication region and a second indication region; and
when the locking member is in the locked position, the first indication region of the indicator faces the display window, and when the locking member is in the unlocked position, the second indication region of the indicator faces the display window.

20. The safety belt adjustment system according to claim 8, wherein the seat housing is provided with a reminder device configured to remind a position state of the locking member; and
wherein the reminder device comprises a sound reminder and/or a display reminder.

21. (canceled)

22. The safety belt adjustment system according to claim 10, wherein the support comprises a first sidewall and a second sidewall opposite to the first sidewall, a first end of the retracting shaft extends through the first sidewall, and a second end of the retracting shaft extends through the second sidewall;
the ratchet is mounted at the first end of the retracting shaft, and the retractor is mounted at the second end of the retracting shaft;
the pivot arm is pivotally connected to the first sidewall through the third pivot, and the pivot arm is positioned on an outer side of the first sidewall;
two locking gears are provided, one of the two locking gears being close to an inner side of the first sidewall, and the other of the two locking gears being close to an inner side of the second sidewall; and
a length of the lock pin portion spans the first sidewall and the second sidewall, and the first sidewall and the second sidewall are each provided with the first groove.

23. (canceled)

24. The safety belt adjustment system according to claim 6, further comprising a pulling mechanism comprising the cable;
wherein when the safety belt is switched from the unbuckled state to the buckled state, the pulling mechanism drives, through the cable, the pawl to be separated from the ratchet.

25. The safety belt adjustment system according to claim 24, wherein the safety belt is provided with a first buckle;
the safety belt adjustment system further comprises a crotch belt provided with a second buckle;
the pulling mechanism comprises a rod member, the cable, and a fourth elastic member. the rod member and the fourth elastic member being mounted in the second buckle, the fourth elastic member driving the rod member to enable a first end of the rod member to protrude from the second buckle, a second end of the rod member being connected to a first end of the cable, a second end of the cable being connected to the pawl; and
when the first buckle and the second buckle are fastened to each other, the rod member is pushed by the first buckle and retracts into the second buckle to drive the cable to pull the pawl.

26. A child safety seat, provided with the safety belt adjustment system according to claim 1.
